(19) United States
(12) Patent Application Publication
(10) Pub. No.: US 2006/0095289 A1
(43) Pub. Date: May 4, 2006

(54) Warranty tracking systems and methods

(76) Inventor: Michel L. Bunning, Lackland Air Force Base, TX (US)

Correspondence Address: CERMAK & KENEALY LLP, 515 E. BRADDOCK RD, SUITE B, ALEXANDRIA, VA, 22314, US

(21) Appl. No.: 11/263,118

(22) Filed: Nov. 1, 2005

Related U.S. Application Data
(60) Provisional application No. 60/623,338, filed on Nov. 1, 2004.

(51) Int. Cl. G06Q 99/00; G06Q 20/00; G06G 1/14

(52) U.S. Cl. 705/1; 705/22; 705/28

(57) ABSTRACT

A warranty tracking system associates products and/or their sub-components with warranties and/or guarantees on them, and with the consumer who owns the product. When the consumer needs to investigate whether a warranty claim can be made on the product, the system provides information on the warranty, and optionally can provide the materials necessary to return the product to the manufacturer. Registration of the product can be optionally enhanced by associating the customer's system ID with the product at the retailer's point-of-sale.

This application claims priority under 35 U.S.C. 119 to U.S. provisional application No. 60/623,338, by Michel L. Bunning, entitled “Warranty Keeper System”, filed 1 Nov. 2004, the entirety of which is incorporated by reference herein.

### BACKGROUND OF THE INVENTION

1. Field of the Invention

The present invention relates to devices, systems, and processes useful for tracking the status of warranties on products, and more specifically to a computer-implementable system by which consumers, retailers, and manufacturers can manage warranties and guarantees.

2. Brief Description of the Related Art

When contemplating returning a product, consumers face a myriad of dilemmas, such as:

Is the original packaging required?

Can and how do I return a gift item?

Do I need the receipt?

How long do I have to return the item?

What is the return policy for CD's and DVDs?

Can I return opened food items?

Will I get store credit or cash?

An unfortunate result of the foregoing is that, in many cases, the consumer of a product is overwhelmed by the prospect of communicating with the product's retailer and/or manufacturer, and opts to not try to enforce the warranty and/or guarantees that cover the product. Thus, a consumer foregoes their rights to enjoy the use of the product when it is partly or completely inoperative or defective, when the consumer could have a repaired or replaced product instead.

Manufacturers that produce quality products know this translates commercially into name recognition, drawing first-time buyers and then keeping their customers. Most quality products come with a manufacturer's warranty. For the warranty to be valid, manufacturers require the costumer to file the appropriate paperwork with the manufacturer, often including the sales receipt. It is often the case, however, that very few customers file the necessary paperwork to validate the warranty and even fewer ever file a claim, even when there is a problem. There may be many reasons for these low numbers, but the two most important are: difficulty in making the appropriate copies, knowing what is required, and then filing the paperwork by the manufacturers deadline; and, if a product fails to meet the manufacturer warranty, to find all the necessary paperwork, ship the item, and communicate with the manufacturer. Even when these first two items are successful, it is often difficult to decipher the warranty's meaning and consumers can become confused and intimidated by the proposition of fulfilling the manufacturer's requirements. The difficulty in filling out the paperwork and then filing it with the company results in many costumers not taking advantage of the warranty. If a product has a problem, the costumer's satisfaction with the product will be negatively influenced, erroneously in some cases, because they failed to fill out and/or file the appropriate paperwork. In many cases the manufacturer would have repaired or replaced the item maintaining costumer loyalty.

There remains a need, therefore, for systems and methods that alleviate the burdens put on consumers by complex and numerous warranties and guarantees of products.

### SUMMARY OF THE INVENTION

According to a first aspect of the invention, a system for tracking product warranty information comprises a database configured and arranged to store data representative of a product warranty and of a customer's unique account identifier, and logic in communication with the database to read data from and write data to the database, the logic configured to communicate data via the internet to a customer computing device, generate a user interface on the customer computing device, and present to the customer on the customer computing device data representative of a product warranty.

According to another aspect of the present invention, a system for tracking product warranty information comprises database means for storing data representative of a product warranty and of a customer's unique account identifier, and means for communicating with the database, for reading data from, and writing data to, the database, said means for communicating data via the internet to a customer computing device, generating a user interface on the customer computing device, and presenting to the customer on the customer computing device data representative of a product warranty.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 diagrammatically illustrates an embodiment of a system exemplifying principles of the present invention;

FIG. 2 schematically illustrates an embodiment of logic and of a process exemplifying further principles of the present invention;

FIG. 3 schematically illustrates an embodiment of logic and of a process exemplifying yet further principles of the present invention; and

FIGS. 4 and 5 schematically illustrate additional embodiments of logic and of processes exemplifying principles of the present invention.

### DETAILED DESCRIPTION OF EXEMPLARY EMBODIMENTS

Referring to the drawing figures, like reference numerals designate identical or corresponding elements throughout the several figures.

Throughout this description, the following non-limiting definitions will aid in a better understanding of the principles of the present invention, but are neither exclusive nor exhaustive of the persons or things they define.

Customer: an individual or business who uses a system of the present invention.

Consumer: an individual or business that purchases any item that has a warranty and/or guarantee.

Warranty: a guarantee, usually in writing, of the integrity of a product and the good faith of the maker given to the purchaser and generally specifying that the maker will for a period of time be responsible for the repair or replacement of defective product, or parts of the product, and will optionally also provide periodic servicing.

Guarantee: an expressed assurance of satisfaction, by a seller or maker of a product to a consumer of a product, with a definite promise of purchase money to be returned or goods to be replaced or other specified assurance.

Manufacturer: an entity that produces the product.

Retailer: an entity that carries a product for purchase by the consumer, which may include a manufacturer.

In general, systems and processes in accordance with the present invention include logic, e.g., software that electronically captures and maintains a database with warranty information both for the individual or corporate user on all purchased items covered by a warranty. A system of the present invention can eliminate the need to keep receipts, manuals, boxes, and packing material, in the event that return of the product, or a part of the product, is necessary to enforce a warranty or guarantee.

One aspect of the present invention includes an internet-based program that electronically registers, maintains, and tracks manufacturer warranties and retailer guarantees for products purchased by a consumer. The costumer takes a license to the system initially, either from a retail establishment or is directly downloaded via the internet from a web site, and then pays an annual fee for maintaining and updating their database and services. A system of the present invention maintains and provides access to the database of the consumer's product warranties, on-line access to manuals for warranted products, parts and supply replacements, accessed by item, and access to costumer friendly return/repair systems.

According to one exemplary embodiment, client-side application software is loaded on the costumer's personal or business general purpose computer (“PC”), for which internet access and an e-mail account are optionally required, and the costumer's demographics are entered during installation. When the consumer purchases a warranted or guaranteed item, information that uniquely identifies that product, e.g., the UPC code, is entered into the system's database by one of two methods. The customer can enter the information manually from their computer, or they can have the retailer from which they purchased the item enter data that uniquely identifies the customer, e.g., scan a unique bar code card kept on the customer's key chain. The retailer's computer system notifies a system of the present invention of the purchase, which automatically registers the product with the warrantor and/or guarantor, and associates the purchase with the customer's/consumer's account.

A system of the present invention optionally can notify the costumer, e.g., via e-mail, post, telephone, or other methods, of successful product registration and any additional warranty information, and from then on notify the costumer of any product recalls, as well as alerting the customer, e.g., 30 days prior to the termination of the warranty, and optionally offering an extended warranty. If the costumer has a problem with a product they can review on-line to see if this particular problem is under warranty and find out what actions they need to take to have their product repaired and/or a replacement issued. If the costumer elects to return an item to the manufacturer, either for repair or replacement, a system of the present invention can send a prepaid shipping box with the necessary paper work, optionally for a fee. Included in this service can optionally be a pre-paid shipping label, packaging materials, and any needed return documentation.

If the customer elects to return the product independently, a system of the present invention can provide a printable return label, any necessary return documentation, and calculate the amount of postage needed to return the item. This process is simplified because the registration of the product with a system of the present invention will automatically record the identity of the retailer, doing away with the need for a paper receipt, and contacting the manufacturer and/or retailer directly.

A list of the motivating factors to encourage Retailers to participate in a system of the present invention includes, but is not limited to: attracting new costumers (Customers will look for products that participate in such a system); improve costumer loyalty; improve costumer satisfaction when returns are necessary; identification of defective products, with an organized method to quickly identify problem products/manufactures, and remove items from the shelf; improve sales for replacement parts, and the secondary market; decrease fraud; decrease costs related to customer service issues; and decrease the amount of inquiries regarding a Retailer's return policies.

These advantages and improvements can allow retailers to redirect customer service monies and energies into other areas there by increasing sales and profits. Each of the areas addressed above are elucidated below.

Customers will view the participation of retail stores using a system of the present invention as an added benefit to shopping, a built-in return protection policy by the retailer. The system also reiterates the retailer's beliefs in their return policies and makes returning, as well as warranty claims, more consumer-friendly. In return, customers will identify stores that make this service available and will see this service as the sole reason to patronize a particular retailer.

Retailers will have a computerized method of determining returned numbers by product; and reasons behind the return, thus rapidly identifying common problems (e.g., possible needed education or change in expectation) and/or defective items and alerting manufacturers, and when necessary removing product from the shelf or cautioning customers to the store-identified concerns, thereby decreasing customer dissatisfaction with poor products and improving manufacture-retailer-costumer relations. Additionally, reducing further sales of a poor product, returning items to manufacturers earlier, decreasing customer complaints, and decreasing labor costs by decreasing returns on unfavorable products, are all possible further benefits of the present invention.

Costumers that need replacement parts, and/or additional complementary equipment or products, can be advised by a system of the present invention if the original retailer has the desired items available, thereby expanding the secondary product support market for products that have replacement equipment, e.g., if a costumer purchases an automatic coffer maker and needs a new glass coffee pot or other associated items that are compatible with the original product, a system of the present invention can alert the customer if the original retailer carries these products or provide other sources if that is not the case.

The shopper will be able to get retailer-specific guidance on all of these questions by simply contacting the on-line service portion of the present system. If the item is returnable to the retailer the costumer will arrive at the retailer fully aware of the return policies. Additionally, the costumer does not need to keep a copy of the store receipt and the retailer will be assured the item being returned was “purchased” from their store(s). Retailers using a system of the present invention will eliminate fraudulent returns from customers using the system, allowing the retailer to focus scarce resources on other areas, decreasing labor overhead. Retailers may wish to extend additional return leniency to customers using the system, to encourage greater participation.

In the event a particular item has a national recall, retailers will have the capability through a system of the present invention, for those customers wishing to be notified, to contact them regarding the recall, reducing the potential for injury and improving community stature for the retailer.

A system of the present invention can also assist Customers navigate the often complicated process of registering for a product's warranty, and can step in to help the costumer file the paperwork, provides the ability for manufacturers to have direct contact with consumers, expanding and in some cases developing after sales market for product accessories as well as keeping costumers abreast of new products. Additionally, a system of the present invention can improve the costumer's satisfaction with products covered by warranty, increasing long-term sales.

Registering warranties with a system of the present invention can thus be automated, and in most cases, can be completed at the point of sale. There is optionally also an option to register from home when a retailer does not offer the service.

Yet another advantage to the manufacturer will be the direct communication link to the consumer. When a recall is necessary, a system of the present invention will be able to identify and notify customers, resulting in faster response time and more satisfied consumers, simultaneously improving customer loyalty. This same communication method can be utilized to share positive information as well, such as product upgrades, or manufacturer recognition and awards. A system of the present invention will provide a mechanism for manufacturers to receive feedback from consumers, create personalized surveys, or hear suggestions from the users of their products. Manufacturers will also have access, for a fee, to the warranty history of similar products in order to assess criteria and make improvements.

Manufacturers will also be able to reduce customer service staff that currently provides information to costumers regarding return policies or warranty information. By providing on-line access to manuals, a system of the present invention can reduce unnecessary returns and reroute trouble-shooting questions to the system's help-line. If a product does need to be returned to the manufacturer, a system of the present invention can create a return form for the customer, as well as a shipping label, that will simplify the return process and minimize miscommunication between the manufacture and consumers. Additionally, a system of the present invention can optionally rate products based on volume of customer service issues, product replacement, and reviews by consumers, and post these ratings on the website. This service will encourage customers to purchase quality, reliable products and a system of the present invention will make personalized recommendations for customers based on their previous purchases. Another advantage of a system of the present invention is that it encourages communication between the Manufacturer and the Retailer, minimizing costly mistakes and controlling returns or recalls.

There are also numerous advantages for Consumers when using a system of the present invention. Current customer trends indicate few warranty claims are ever filed, even though products are covered by either retailer or manufacturer warranties. For the consumer, a system of the present invention will provide a mechanism to capture product reliability by providing retailer/manufacturer accountability, as well as a simplified method for maintaining warranty information.

Most retail products include a manufacturer warranty, which in most cases is limited with a requirement of registration of the product as well as the retail receipt. Some products come with a limited warranty that does not require registration, but to file a claim with the manufacturer the consumer would need to keep the original packing material and associated materials. A system of the present invention can eliminate the need for the customer to complete product registration and the need to keep manuals as well as receipts. If a product is unsatisfactory or malfunctions, the costumer could access their account, examine the warranty, and ask the system to forward a preaddressed and prepaid shipping box to return the item. If questions arise, the customer can access a 24-hour help-line and speak with personnel who specialize in product replacement or return.

If a replacement piece or accessory for a product is needed, purchase information will be available from the present system, and should a product be unavailable, a system of the present invention can show the customer items most similar to the original product. This will eliminate unnecessary visits to retailers and put the consumer in direct contact with the manufacturer when required.

Another consumer advantage is the ability to access product user manuals whenever necessary. Thus, the system's database optionally includes such manuals accessible through an internet site, and a system of the present invention can eliminate the need for consumers to keep stacks of paperwork, as well as providing an alternative when paperwork is lost. If a warranty on a particular item has already expired, but now the product is malfunctioning, the user manual may assist in correcting the problem.

Rebates have become a common incentive and, just like returns, often require the customer to have copies of receipts, cut bar codes from original packaging, and a myriad of other requirements that take time and attention. A system of the present invention can file rebates for the customer at the same time the product is registered and offer a method for the company to deposit the money directly into the customer's system account, or mail a check. If the manufacturer mails a check, a system of the present invention can send weekly notices to the customer to insure the rebate has been received and, once received, take this off a reoccurring task list.

When a person purchases a new home, car, recreational vehicle, boat, or other highly complex product, these items come with a general warranty for the item overall. For example, a builder will warranty the entire house for one-year against structural problems, but there are many items that were used in the construction that also have individual warranties. It is estimated that a new house has over 500 warrantable items. Windows, door locks, carpet, and so on often come with their own warranty, the builder can use a system of the present invention to keep track of all the items during construction and transfer this information to the new owner on closing. This same process would be available on items such as cars that have numerous individually warranty items, and/or items with different warranties, that most owners are not even aware of.

With customized recommendations, online manuals, consumer updates, and warranty countdowns, online assistance, consumers can be better equipped to hold manufacturers to their claims using a system of the present invention.

There are even advantages for law enforcement and Customers. As part of the registration phase, many manufacturers require the product serial number in order to index the item. These serial numbers can be made available to law enforcement officials by a system of the present invention, to assist in the reclaiming of stolen property. Although the identity of the owner does not need to be revealed, the serial numbers will be provided, and if a match is discovered, a system of the present invention can contact the customer. In a preferred embodiment, this advantageous yet optional feature is a push-only system for costumer identification and a pull system for cross matching identification numbers. Utilizing a system of the present invention can thus assist in the recovery of stolen property as well as acting as a deterrent to thieves.

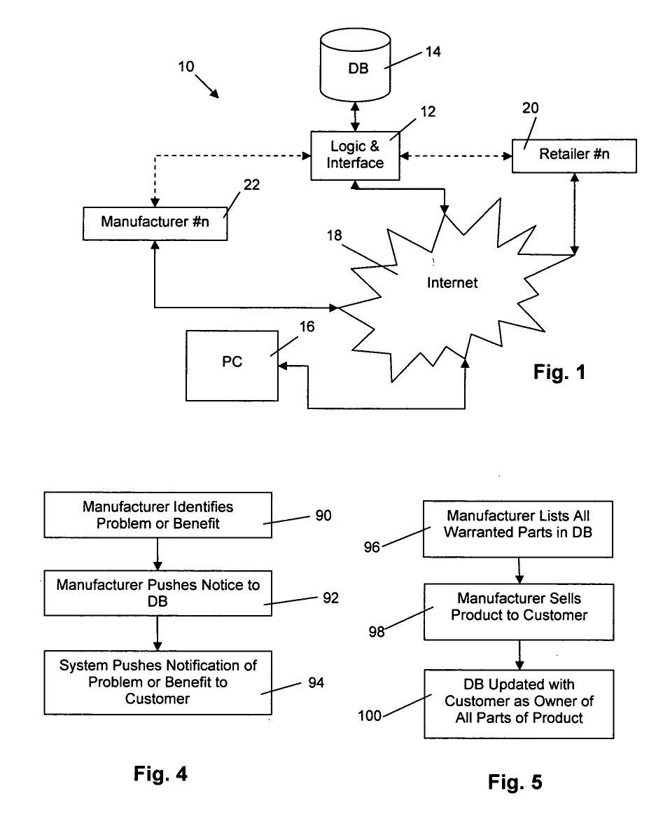

Turning now to the several drawing figures, a number of embodiments exemplifying principles of the present invention are illustrated. FIG. 1 diagrammatically illustrates a top-level view of the configuration of a system 10 in accordance with the present invention. A customer's personal computer (“PC”) 16 is connected to the internet 18 through one or more known ways. The logic, optionally including the logic to generate a user interface, 12 of the present invention is represented in FIG. 1 as being in a server type position relative to the customer's PC 16, that is, the logic is contained in a computing device other than the PC 16. Of course, other embodiments of the present invention include that some or all of the logic 12 is contained in the memory of the customer's PC 16, leaving only a thin server-side application. The logic 12 is also in communication with the internet, and with a database 14 which contains at least some of the data described herein; optionally, some data, such as owner's manuals and other manufacturer-specific documents can be located on other computing devices or databases, to which the logic 12 and/or the database 14 points.

One or more retailers 20 are also in communication with the logic 12, either through the internet, as indicated by the solid line connection thereto, or directly through a dedicated connection, as suggested by the dotted line connection. Preferably, one or more manufacturers are in communication with the logic 12, also either directly or through the internet. As described above, the customer, the retailer, and optionally the manufacturer are all in communication with the logic 12 and, through the logic, the database 14, permitting the customer and/or the retailer to register products, warranties, and/or guarantees, order supplies and parts, and receive information about products.

The functionality of the logic 12 and the structure of the database 14 of the present invention are preferably embodied in a set or sets of instructions or scripts that are contained in a memory and are executable by a general purpose computing device. Because the present invention is not limited to any particular scripting language or database type, the present invention can be implemented in many different computing environments which are well known to those of ordinary skill in the art.

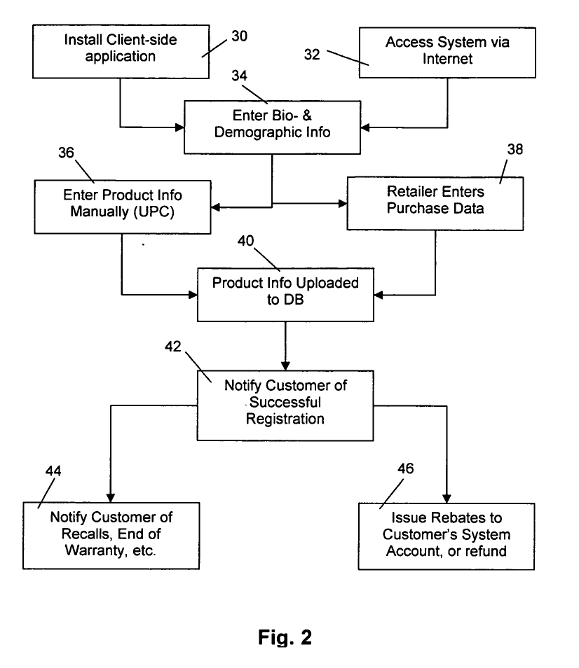

With reference to FIG. 2, a number of aspects of the logic 12 the present invention are illustrated. A customer can install 30 a client-side application, embodying some or all of the logic 12, on the PC 16, and preferably enters in 34 biographic and demographic information, which is then passed on to the database 14; such information can include, but is not limited to: First Name; Middle Initial; Last Name; Maiden Name; Month of Birth; Year of Birth; Mailing Address; Physical Address; Phone Number; E-Mail Address; Credit Card Information; and Survey Information. Alternatively, when the logic 12 is entirely embodied in server-side logic, the customer accesses 32 their account by using the PC 16 to navigate to a URL or IP address of a computing device which provides access to a web-browser interface generated by the logic 12; the customer may then start to populate 34 the database 14 with data. When the customer wants to benefit from the system 10 for a product that she has obtained, she enters in 36 information about the product, e.g., manufacturer's name, product name, and other identifying indicia so that the product can be uniquely identified. The logic 12 optionally provides cascading menus to sequentially narrow the description of the product, so that the product is correctly identified. Alternatively, and preferably, the retailer of the product conducts this task 38 during purchase of the product by, for example, associating the customer's unique identification code or account number with the purchase of the product, which can be identified by UPC or the like. The data concerning the particular product, and its association with the particular customer, is then uploaded 40 to the database 14, and the customer and/or retailer is notified of the successful database update. Thereafter, the logic 12 can push notifications to the customer of product recalls, the impending expiration of a warranty, or the like, and can issue refunds, rebates, and other benefits from purchasing the product, which are specific to the product purchased. Further optionally, such monetary benefits can be credited to the customer's account on the system 10, thus eliminating the need to generate checks or crediting a credit account; optionally, checks can be generated and mailed, or a credit account credited.

The database 14 includes information about the customer, the products that the customer has registered with the system 10, and other related information, including, but not limited to: the foregoing biographic and demographic information; product name; product unique identifier, e.g., UPC; product serial number; retailer ID; product warranty time; description of warranty; manual or link to product manual; list or pointers to subcomponents or parts of the products; return information; repair instructions; indicator that the product has been returned; indicator that a warranty claim has been made for the product; rebate amount given; and rebate date given.

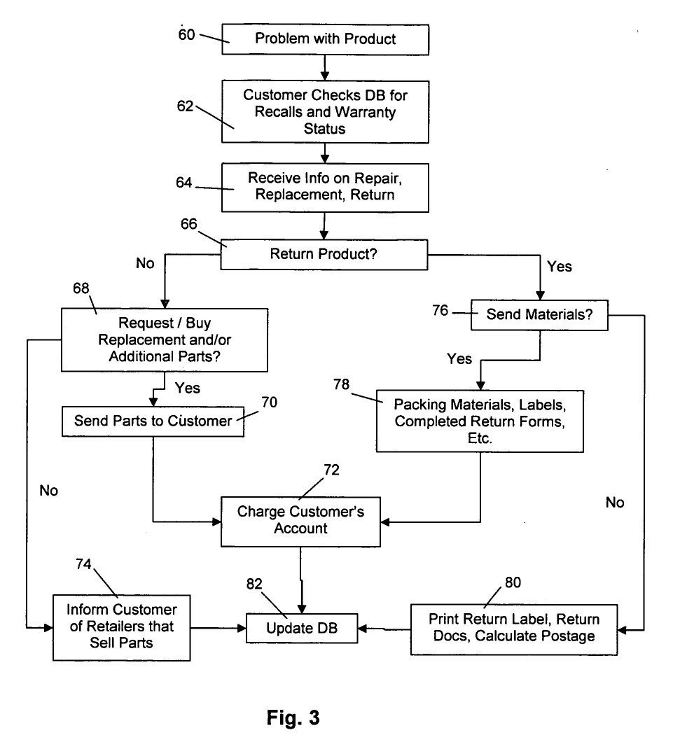

FIG. 3 schematically illustrates another portion of logic 12. When there is a problem 60 with a product that has been identified in the database 14, the customer checks 62 in the database for any recalls and/or the status of any warranty on the product. The logic 12 returns 64 information from the database 14 on how to repair, replace, and/or return the product. The customer then decides 66 if they wish to return the product. If not, the customer decides 68 to request and/or buy replacement parts, and/or purchase additional parts of the product, to rectify the problem. If the customer decides to have the system 10 send parts to the customer, the logic generates an order 70 to send the parts, with any necessary installation instructions, to the customer, and the customer's account with the system is charged 72 for the parts. If the customer decides not to order any parts, the logic informs 74 the customer of any retailers that sell the particular part or parts.

If the customer instead elects, at step 66, to return the product, the logic 12 queries the customer 76 whether or not materials should be sent to the customer to facilitate the return of the product. If yes, the logic generates an order internal to the system 10 to ship to the customer packing materials, labels, completed return forms, etc., specific to the product and to the manufacturer or retailer to which the product will be returned. Because the product has already been uniquely identified in the database 14, including all of the unique data concerning the warranty and return policies of the manufacturer and retailer, the logic 12 can easily generate these materials. Furthermore, the system can eliminate the need for the customer to supply the original (or copy of the) receipt for the purchase of the product, because the product has been registered through the system 10 with the manufacturer and/or retailer. The customer's account is then charged 72 for the materials and the service of providing them.

If the customer elects instead, at step 76, not to receive the customized return materials (at step 78), the logic 12 generates 80 a return label, the return documents, and can calculate the postage, all specific for the return of the product to the manufacturer or retailer, which can be printed out by the customer using PC 16 (e.g., the customized documents can be provided to the customer in image format).

At the conclusion of the foregoing processes, the database 14 is updated 82 with the status of the product and the particular activity that the customer has engaged in.

Yet further optional aspects of the logic 12 are illustrated schematically in FIGS. 4 and 5. When a manufacturer identifies 90 a problem or benefit with a product, the manufacturer, through its connection to the logic 12 and database 14, can push notification of the issue to the database 14, and the logic 12 pushes the notice to the customer, such as via email or post. Another advantageous aspect of the present invention is illustrated in FIG. 5. A manufacturer, again via its access to the database 14, lists 96 all of the parts or subcomponents of a product, e.g., a vehicle, a house, a computer, or other multi-component product, as well as the product itself, and an account identifier; this may be performed either before or after the product is sold. If it is performed before the product is sold, the identifier is the manufacturer's identifier. When the product is sold 98 to the customer, the customer's unique ID is associated 100 with the product and all of its subcomponents or parts as the owner, thus eliminating the need for the customer to do more than merely have an account with the system. In this manner, a customer can benefit from all of the different warranties that may be provided with the product, without the need to separately track the warranties herself.

While the invention has been described in detail with reference to exemplary embodiments thereof, it will be apparent to one skilled in the art that various changes can be made, and equivalents employed, without departing from the scope of the invention.

What is claimed is:

1. A system for tracking product warranty information, the system comprising:
a database configured and arranged to store data representative of a product warranty and of a customer's unique account identifier;
logic in communication with the database to read data from and write data to the database, the logic configured to
communicate data via the internet to a customer computing device;
generate a user interface on the customer computing device; and
present to the customer on the customer computing device data representative of a product warranty.

2. A system according to claim 1, wherein the logic is also configured to communicate with a retailer computing device to permit the retailer to upload data into the database representative of a unique product identifier and a customer's unique account identifier.

3. A system according to claim 1, wherein the logic is also configured to communicate with a manufacturer computing device to permit the manufacturer to upload data into the database representative of a plurality of unique product identifiers and an unique account identifier, the unique account identifier being the manufacturer's or the customer's.

4. A system according to claim 1, wherein the logic is also configured to permit the customer to request materials be delivered to the customer for the return of the product.

5. A system according to claim 4, wherein the materials are selected from the group consisting of packing materials, labels, return forms, and combinations thereof.

6. A system according to claim 1, wherein the logic is also configured to permit the customer to request replacement parts of the product to be delivered to the customer.

7. A system according to claim 1, wherein the logic is also configured to read data from and write data to the database representative of product information, consumer information, or both, selected from the group consisting of: biographic information; demographic information; product name; product UPC; product serial number; retailer ID; product warranty time; description of warranty; product manual; list of parts of the product; pointers to parts of the product; return information; repair instructions; indicator that the product has been returned; indicator that a warranty claim has been made for the product; rebate amount given; rebate date given; and combinations thereof.

8. A system according to claim 1 wherein the logic is also configured to generate mail to the customer including information concerning problems with or benefits from the product.

9. A system for tracking product warranty information, the system comprising:
database means for storing data representative of a product warranty and of a customer's unique account identifier;
means for communicating with the database, for reading data from, and writing data to, the database, said means for
communicating data via the internet to a customer computing device;
generating a user interface on the customer computing device; and
presenting to the customer on the customer computing device data representative of a product warranty.

10. A system according to claim 9, wherein the means is also for communicating with a retailer computing device to permit the retailer to upload data into the database representative of a unique product identifier and a customer's unique account identifier.

11. A system according to claim 9, wherein the means is also for communicating with a manufacturer computing device to permit the manufacturer to upload data into the database representative of a plurality of unique product identifiers and an unique account identifier, the unique account identifier being the manufacturer's or the customer's.

12. A system according to claim 9, wherein the means is also for permitting the customer to request materials be delivered to the customer for the return of the product.

13. A system according to claim 12, wherein the materials are selected from the group consisting of packing materials, labels, return forms, and combinations thereof.

14. A system according to claim 9, wherein the means is also for permitting the customer to request replacement parts of the product to be delivered to the customer.

15. A system according to claim 9, wherein the means is also for reading data from and writing data to the database representative of product information, consumer information, or both, selected from the group consisting of: biographic information; demographic information; product name; product UPC; product serial number; retailer ID; product warranty time; description of warranty; product manual; list of parts of the product; pointers to parts of the product; return information; repair instructions; indicator that the product has been returned; indicator that a warranty claim has been made for the product; rebate amount given; rebate date given; and combinations thereof.

16. A system according to claim 9 wherein the means is also for generating mail to the customer including information concerning problems with or benefits from the product.
